(19) United States
(12) Patent Application Publication
(10) Pub. No.: US 2025/0219707 A1
(43) Pub. Date: Jul. 3, 2025

(54) METHOD, NETWORK CONTROLLED REPEATER, AND ACCESS NETWORK NODE

(71) Applicant: NEC Corporation, Minato-ku, Tokyo (JP)

(72) Inventors: Yuhua CHEN, London (GB); Satoaki HAYASHI, Tokyo (JP)

(73) Assignee: NEC Corporation, Minato-ku, Tokyo (JP)

(21) Appl. No.: 18/875,182

(22) PCT Filed: Aug. 1, 2023
(86) PCT No.: PCT/JP2023/028184

§ 371 Date: Dec. 16, 2024

(30) Foreign Application Priority Data
Aug. 9, 2022 (GB) 2211654.5

(51) Int. Cl. H04B 7/06; H04W 72/0446

(52) U.S. Cl. CPC H04B 7/06952; H04W 72/0446

(57) ABSTRACT

The present disclosure relates to a method for a network controlled repeater, NCR the method comprising: receiving a first beamformed transmission from an access network node; and transmitting, based on the first beamformed transmission, a plurality of second beamformed transmissions; wherein each of the second beamformed transmissions is transmitted in a different direction.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements related to network controlled repeaters (NCR) and beamformed signals.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, NPL 1.

In a communication network a UE may fall outside of a transmission range of a base station. However, a repeater may be provided that receives transmissions from the base station and retransmits the received signals to effectively extend the range of the base station. The UE is therefore able to communicate with the base station via the repeater. The repeater provides a flexible alternative to extending the coverage of the network without deploying additional regular full-stack cells. The repeater may be referred to as a radio frequency repeater (RF repeater). A simple repeater may receive a signal from the base station and simply broadcast the received signal omnidirectionally. In other words, a RF repeater may simply amplify and forward signals it receives from the base station, so as to provide an area of extended coverage. Whilst RF repeaters provide a relatively cost-effective method of extending network coverage, simple amplification and omnidirectional forwarding may not be suitable when the original transmission from the base station is beamformed and beam sweeping is desired.

A repeater may be required by the network to transmit the received signal as a beam in a particular direction at a particular time, and may need to be configured to receive a signal from a UE from particular direction at a particular time and frequency on an access link. In order to inform the repeater of configuration information for transmitting and receiving beamformed signals, the repeater may receive corresponding control information from the base station. Such repeaters may be referred to as ‘network controlled repeaters’ (NCR), and the control information received from the base station may be referred to as ‘side control information’.

In a system using beamformed signals, a base station may transmit a signal with a first resource set at different beam directions for direct access, for UEs within the normal unextended range of the base station. The base station may also transmit the signal with a second resource set for forwarding by the repeater. The repeater then transmits/forwards in a corresponding set of beams that are configured according to control information received from the base station. In other words, the base station transmits signals with a first resource set in a first direction for direct access, and a second resource set for one or more beamformed signals directed for relay by the repeater. Each resource having a corresponding beam may be identified by a corresponding index. For example, when the index corresponds to a syncronisation signal block (SSB), an SSB index may be used. Depending on measurements of the signal transmitted on each resource by the UE and the corresponding SSB indices, the base station is able to determine whether the UE is in the area of direct coverage provided by the base station, or whether the UE is within the extended area of coverage provided by the repeater.

### CITATION LIST

### Non Patent Literature

NPL 1: ‘NGMN 5G White Paper’ V1.0 by the Next Generation Mobile Networks (NGMN) Alliance, <https://www.ngmn.org/5g-white-paper.html>
NPL 2: 3GPP TS 38.213 V16.7.0
NPL 3: 3GPP TS 38.300 V16.7.0
NPL 4: 3GPP TS 37.340 V16.7.0
NPL 5: 3GPP TS 22.368 V13.1.0

### SUMMARY OF INVENTION

### Technical Problem

However, this method of transmitting with additional resource sets for forwarding by the repeater may not be efficient for some types of broadcasts and common signalling, such as system information block 1 (SIB1) or paging, due to the large number of additional transmissions required from the base station for the forwarded beams. The additional transmissions for forwarding by the repeater requires additional communication resources, and increases the risk of interference for UEs that are located within the area of direct coverage of the base station but may also receive the additional transmissions directed towards the repeater. Moreover, when additional transmissions using additional resources for repeating are used, the number of transmissions/resources that must be used by the base station increases rapidly with increasing number of repeaters, since each repeater requires an additional set of transmissions/resources for forwarding.

There is a need, therefore, for improved apparatus and methods for systems using beamformed signals. For example, there is a need for improved base stations and network controlled repeaters that provide improved efficiency, reduced noise, improved spatial directivity and simplified network integration.

The present disclosure seeks to provide methods and associated apparatus that address or at least alleviate (at least some of) the above-described issues.

### Solution to Problem

In one aspect the disclosure provides a method for a network controlled repeater, NCR the method comprising: receiving a first beamformed transmission from an access network node; and transmitting, based on the first beamformed transmission, a plurality of second beamformed transmissions; wherein each of the second beamformed transmissions is transmitted in a different direction.

The method may further comprise: performing a signal measurement of the first beamformed transmissions; and determining, based on the signal measurement, to transmit the plurality of second beamformed transmissions based on the first beamformed transmission.

The method may further comprise determining a receive time window corresponding to the first beamformed transmission.

The method may further comprise receiving NCR control information for controlling at least one of transmission or reception of beamformed signals at the NCR.

The NCR control information may indicate at least one of a spatial, time or frequency resource to use to transmit the plurality of second beamformed transmissions.

The NCR control information may indicate at least one of a spatial, time or frequency resource to use to receive a beamformed signal.

The NCR control information may indicate at least one of a spatial, time or frequency resource to use to receive a signal from a UE over an access link.

The NCR control information may indicate at least one of a spatial, time or frequency resource to use to receive a signal from the access network node over a backhaul link.

Each of the plurality of second beamformed transmissions may be transmitted in different transmission periods.

The plurality of second beamformed transmissions may correspond to the transmission of at least one of syncronisation signal block, SSB, System Information, SI, or a paging transmission.

The first beamformed transmission may be for direct access by a user equipment, UE, within an unextended transmission range of the access network node.

A beam direction corresponding to the first beamformed transmission may be the same as a beam direction used for a control link between the NCR and the access network node.

Transmitting the plurality of second beamformed transmissions may comprise transmitting a plurality of second beamformed transmissions each time the first beamformed transmission is received at the NCR.

Transmitting the plurality of second beamformed transmissions may comprise transmitting a single one of the second beamformed transmissions each time the first beamformed transmission is received at the NCR.

In one aspect the disclosure provides a method for a network controlled repeater, NCR, the method comprising: receiving a first beamformed transmission from an access network node; performing a beam tuning procedure to tune a beam that corresponds to a control link between the NCR and the access network node, to obtain a tuned beam configuration; and using the tuned beam configuration for a beam that corresponds to a backhaul link between the NCR and the access network node.

The method may further comprise using the tuned beam configuration for a beam that corresponds to transmission of at least one of system information, SI, paging, or a dedicated channel for reception at the NCR.

In one aspect the disclosure provides a method for an access network node, the method comprising: transmitting a first beamformed transmission for reception by a network controlled receiver, NCR; performing a beam tuning procedure to tune a beam that corresponds to a control link between the NCR and the access network node, to obtain a tuned beam configuration; and using the tuned beam configuration for a beam that corresponds to a backhaul link between the NCR and the access network node.

The method may further comprise using the tuned beam configuration for a beam that corresponds to transmission of at least one of system information, SI, paging, or a dedicated channel for reception at the NCR.

In one aspect the disclosure provides a network controlled repeater, NCR comprising: means for receiving a first beamformed transmission from an access network node; and means for transmitting, based on the first beamformed transmission, a plurality of second beamformed transmissions; wherein each of the second beamformed transmissions is transmitted in a different direction.

In one aspect the disclosure provides a network controlled repeater, NCR, comprising: means for receiving a first beamformed transmission from an access network node; means for performing a beam tuning procedure to tune a beam that corresponds to a control link between the NCR and the access network node, to obtain a tuned beam configuration; and means for using the tuned beam configuration for a beam that corresponds to a backhaul link between the NCR and the access network node.

In one aspect the disclosure provides an access network node comprising: means for transmitting a first beamformed transmission for reception by a network controlled receiver, NCR; means for performing a beam tuning procedure to tune a beam that corresponds to a control link between the NCR and the access network node, to obtain a tuned beam configuration; and means for using the tuned beam configuration for a beam that corresponds to a backhaul link between the NCR and the access network node.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 shows a schematic diagram of a network-controlled repeater (NCR) arranged between a base station and a UE;

FIG. 3 is a schematic block diagram of a mobile device;

FIG. 4 is a schematic block diagram of a base station;

FIG. 5 shows a schematic block diagram of an NCR;

FIG. 6 shows an example of communication between a gNB and a UE via an NCR;

FIG. 7 shows an example of SSB transmissions for beam sweeping;

FIG. 8 shows a first example of NCR forwarding;

FIG. 9 shows a second example of NCR forwarding;

FIG. 10 shows a further example of communication between a gNB and a UE via an NCR;

FIG. 11 shows a further example of NCR forwarding in which a single beam is transmitted by the NCR within each transmission window;

FIG. 12 shows a further example of NCR forwarding in which multiple beams are transmitted by the NCR within each transmission window;

FIG. 13 shows system in which a beam management procedure of the present disclosure can be implemented;

FIG. 14 illustrates a beam management procedure; and

FIG. 15 shows an example of PRACH receiving via the NCR.

### DESCRIPTION OF EXAMPLE EMBODIMENTS

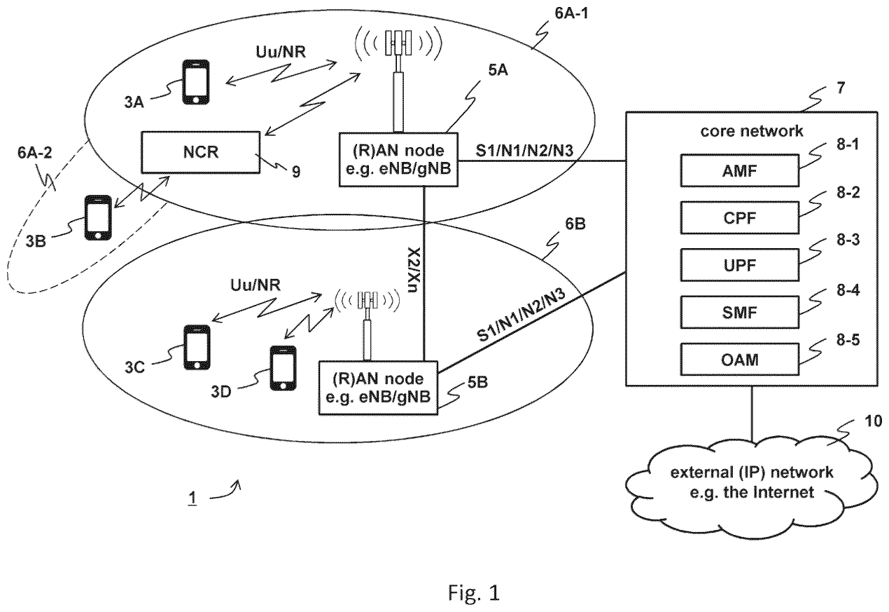

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes 5 and mobile devices (UEs) 3.

Each base station 5 controls one or more associated cells 6 (either directly or via other nodes such as home base stations, relays, remote radio heads, distributed units, and/or the like). In this example, a base station 5A has an area of direct coverage 6A-1 and a further area of coverage 6A-2 provided by a network controlled repeater (NCR) 9. As will be described in more detail later, the UE 3B in the further area of coverage 6A-2 provided by the NCR 9 is able to communicate with the base station 5A via the NCR 9.

A base station 5 that supports Next Generation/5G protocols may be referred to as a ‘gNB’. It will be appreciated that some base stations 5 may be configured to support both 4G and 5G, and/or any other 3GPP or non-3GPP communication protocols. It will be appreciated that a number of base stations 5 form a (radio) access network or (R)AN.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 8-2 and one or more user plane functions (UPFs) 8-3. The core network 7 will also include the so-called Access and Mobility Management Function (AMF) 8-1 in 5G, or the Mobility Management Entity (MME) in 4G, that is responsible for handling connection and mobility management tasks for the mobile devices 3. The Session Management Function (SMF) 8-4 is responsible for handling communication sessions for the mobile devices 3 such as session establishment, modification and release. The Operations, Administration and Maintenance (OAM) function 8-5 may be implemented in software in one or more 5G CN nodes. The core network 7 is coupled to a data network 10, such as the Internet or a similar Internet Protocol (IP) based network.

When the UE 3 initially establishes an RRC connection with a base station 6 via a cell it registers with an appropriate AMF 8-1 (or MME). The UE 3 is in the so-called RRC connected state and an associated UE context is maintained by the network. When the UE 3 is in the so-called RRC idle or in the RRC inactive state, it still needs to select an appropriate cell for camping so that the network is aware of the approximate location of the UE 3 (although not necessarily on a cell level).

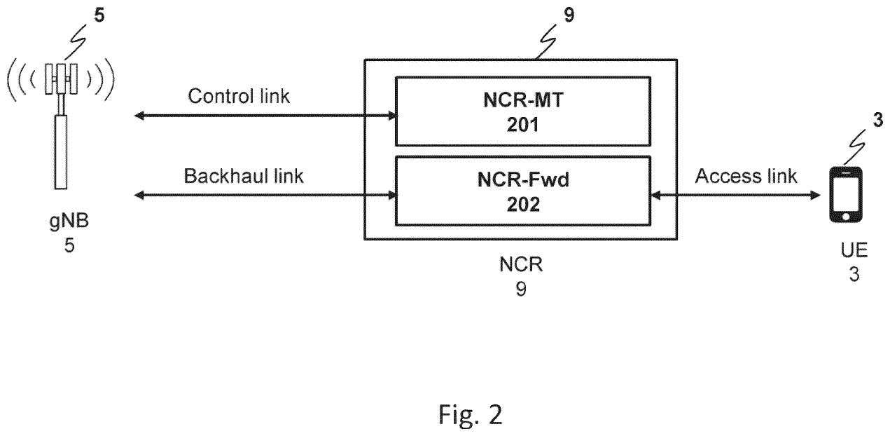

FIG. 2 shows a schematic diagram of the NCR 9 arranged between the base station 5 and the UE 3. The NCR 9 comprises an ‘NCR-Mobile termination’ (NCR-MT) 201 for communication with the base station 5 via a control link (including the reception of ‘side control information’, described in more detail below). The control link is based on the new radio (NR) Uu interface. The NCR 9 also comprises an ‘NCR-Forwarding’ (NCR-Fwd) 202 for communication with the base station 5 via a backhaul link, and for communication with the UE 3 via an access link.

The NCR 9 receives control information from the gNB 5 related to at least one beamformed signal to be transmitted/received by the NCR 9. This control information may be referred to as ‘side control information’. The side control information includes control information for downlink (DL) and/or uplink (UL) transmissions. The behaviour of the NCR-Fwd 202 (e.g. one or more configurations of the NCR 9 related to the backhaul link and/or the access link) is controlled based on the side control information received from the gNB 5.

For DL transmissions, the repeater receives transmissions from the gNB 5 via the backhaul link, and transmits corresponding signals to the UE 3 via the access link. The side control information may control the direction, timing and frequencies of the transmissions on the access link to the UE 3. In other words, the side control information controls the forwarding of transmissions from the gNB 5 to the UE 3 by the NCR 9. For UL transmissions, the NCR 9 receives transmissions from the UE 3 over the access link and transmits corresponding signals to the gNB 5. The side control information may control the direction on which the NCR 9 receives on the access link in a particular time and/or frequency resource window.

The side control information may include configuration information for transmitting the beamformed signals and/or uplink/downlink (UL/DL) time division duplex (TDD) configuration information. The UL/DL TDD configuration information may indicate a semi-static TDD UL/DL configuration for the control link, backhaul link and/or the access link. The same TDD UL/DL configuration may be assumed for the backhaul link and the access link. The same TDD UL/DL configuration may be assumed for the control link, backhaul link and access link if the NCR-MT and the NCR-Fwd are in the same frequency band. More generally, the control information is used for controlling the forwarding behaviour, for UL and/or DL, of the NCR 9.

For downlink signal forwarding, the side control information may comprise information indicating one or more directions, for the access link, in which the NCR 9 is to transmit the signal received from backhaul link at a given time (e.g. time window). For uplink signal forwarding, the side control information may comprise information indicating one or more directions, for the access link, in which the NCR 9 is to receive the signal from the UE and forward to the gNB via the backhaul link at a given time (e.g. time window). The side control information may indicate different directions to be used at different times. The side control information may comprise information for a beam refinement procedure for a beam transmitted by the NCR 9. A beam refinement procedure may be used, for example, when the conditions of a radio link between the UE 3 and the NCR 9 change. The side control information may comprise beam information indicating a beam configuration for the access link. The side control information may comprise a direction in which a transmission from the UE 3 is to be received.

The side control information may comprise information regarding a semi-static and/or dynamic downlink/uplink configuration, adaptive transmitter/receiver spatial beamforming, ON-OFF information (e.g. for more efficient interference management and improved energy efficiency), power control information (e.g. for improved interference management), or any other suitable control information. The ON-OFF information may be for controlling the behaviour of the NCR-Fwd, and may include an explicit indication of an ON-OFF state or an ON-OFF pattern. The ON-OFF information may comprise an implicit indication via signalling for other information such as beam information, DL/UL configuration information, or power control information. The ON-OFF information may comprise a combination of an explicit indication and an implicit indication.

The side control information may comprise timing information to indicate when the NCR 9 is to amplify and forward signals for downlink and/or uplink. The timing information may be for configuring the DL receiving timing of the NCR-Fwd at the backhaul link. The timing information may also, or alternatively, be for configuring the UL receiving timing of the NCR-Fwd at the access link. The NCR-Fwd 202 amplifies and forwards the corresponding received signal to UE 3 in the downlink case, or to the gNB 5 in uplink case.

The side control information may be transmitted from the gNB 5 to the NCR 9 as L1/L2 control signaling. The NCR 9 may obtain configuration information for receiving the L1/L2 signalling via radio resource control (RRC) signalling. Alternatively, the configuration information for receiving the L1/L2 signalling may be received from an operations administration and maintenance (OAM) entity in the network, or may be preconfigured at the NCR 9. In a further alternatively, the configuration information for receiving the L1/L2 signalling may be partially received via RRC signalling and partially received from the OAM entity in the network. The configuration information for receiving the L1/L2 signalling may comprise configuration information for receiving physical downlink control channel (PDCCH) and/or physical downlink shared channel (PDSCH), configuration information for transmitting physical uplink control channel (PUCCH), configuration information for transmitting physical uplink shared channel (PUSCH), configuration information for downlink control information (DCI), configuration information for uplink control information (UCI), and/or configuration information for medium access control control-element (MAC CE).

### User Equipment (UE)

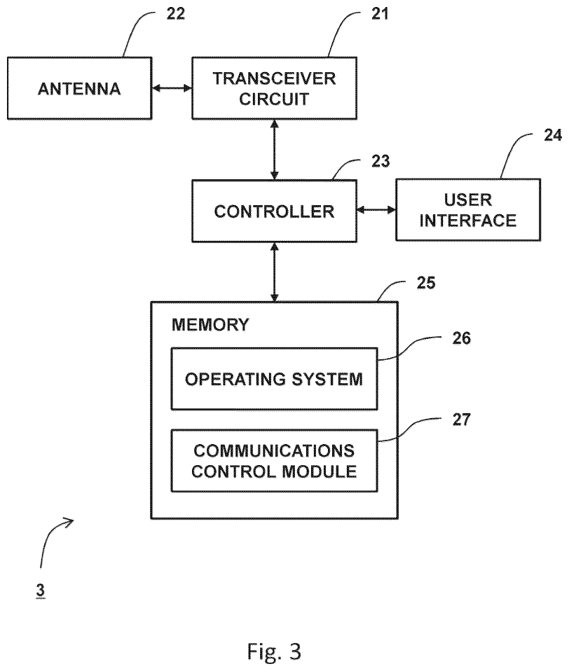

FIG. 3 is a block diagram illustrating the main components of the mobile device (UE) 3 shown in FIG. 1. As shown, the UE 3 includes a transceiver circuit 21 which is operable to transmit signals to and to receive signals from one or more connected nodes via one or more antennas 22. Although not necessarily shown in FIG. 3, the UE 3 will of course have all the usual functionality of a conventional mobile device (such as a user interface 24) and this may be provided by any one or any combination of hardware, software and firmware, as appropriate. A controller 23 controls the operation of the UE 3 in accordance with software stored in a memory 25. The software may be pre-installed in the memory 25 and/or may be downloaded via the telecommunication network 1 or from a removable data storage device (RMD), for example. The software includes, among other things, an operating system 26, a communications control module 27.

The communications control module 27 is responsible for handling (generating/sending/receiving) signalling messages and uplink/downlink data packets between the UE 3 and other nodes, including (R)AN nodes 6, the NCR 9, and core network nodes. The signalling may comprise control signalling (such as RRC signalling) related to configuring and assisting cell reselection by the UE 3.

The UE 3 may receive one or more beamformed signals (e.g. a beamformed signal transmitted by the NCR 9) and may perform corresponding signal strength measurements. The UE 3 may determine to communicate using a particular one of the beams (e.g. the beam having the strongest signal received at the UE during a measurement period). The beam selected by the UE 3 can be identified using the corresponding index (e.g. a syncronisation signal block (SSB) index, or any other suitable index) and used for communication, either directly between the base station 5 and the UE 3 or via the NCR 9 (when the index corresponds to a beam that was transmitted by the NCR 9).

### Base Station/Gateway (Access Network Node)

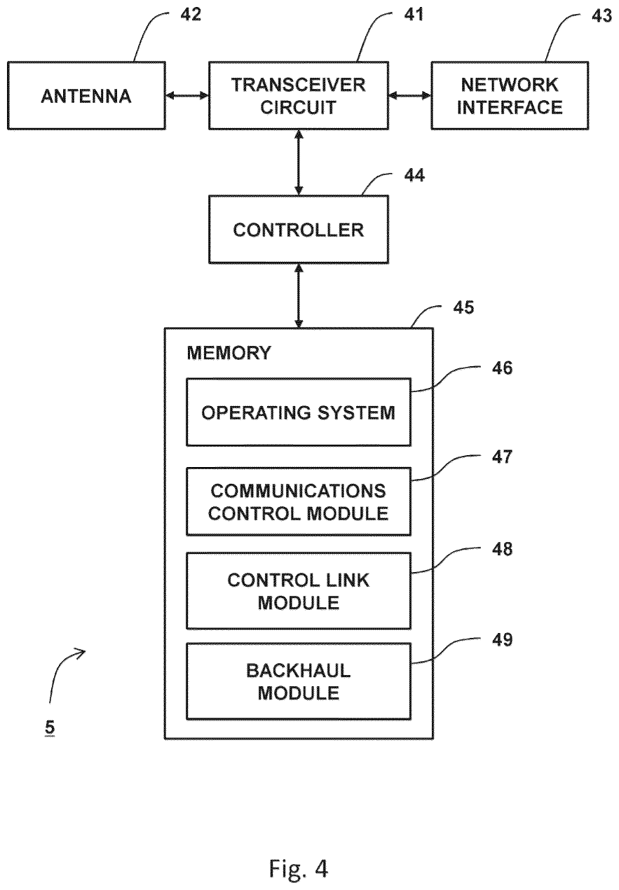

FIG. 4 is a block diagram illustrating the main components of the gateway/base station 5 shown in FIG. 1 (a base station (gNB) or a similar access network node, the base station need not necessarily be a gNB 5). As shown, the base station 5 includes a transceiver circuit 41 which is operable to transmit signals to and to receive signals from one or more UEs 3 or the NCR 9 via one or more antenna 42 and to transmit signals to and to receive signals from other network nodes (either directly or indirectly) via a network interface 43. The network interface 43 typically includes an appropriate base station-base station interface (such as X2/Xn) and an appropriate base station-core network interface (such as S1/NG-C/NG-U). A controller 44 controls the operation of the base station 5 in accordance with software stored in a memory 45. The software may be pre-installed in the memory 45 and/or may be downloaded via the telecommunication network or from a removable data storage device (RMD), for example. The software includes, among other things, an operating system 46, a communications control module 47, a control link module 48 and a backhaul module 49.

The communications control module 47 is responsible for handling (generating/sending/receiving) signalling between the base station 5 and other nodes, such as the UE 3 and core network nodes. The signalling may comprise, for example, control signalling (such as RRC signalling) related to configuring and assisting cell reselection by the UE 3.

The control link module 48 is responsible for controlling communication via the control link with the NCR-MT 201 of the NCR 9. It will be appreciated that the control link module 48 may be configured to control the communication over the control link according to any of the examples described below.

The backhaul module 49 is responsible for controlling communication via the backhaul with the NCR-Fwd 202 of the NCR 9. It will be appreciated that the backhaul module 49 may be configured to control the communication over the backhaul according to any of the examples described below.

### Network Controlled Repeater (NCR)

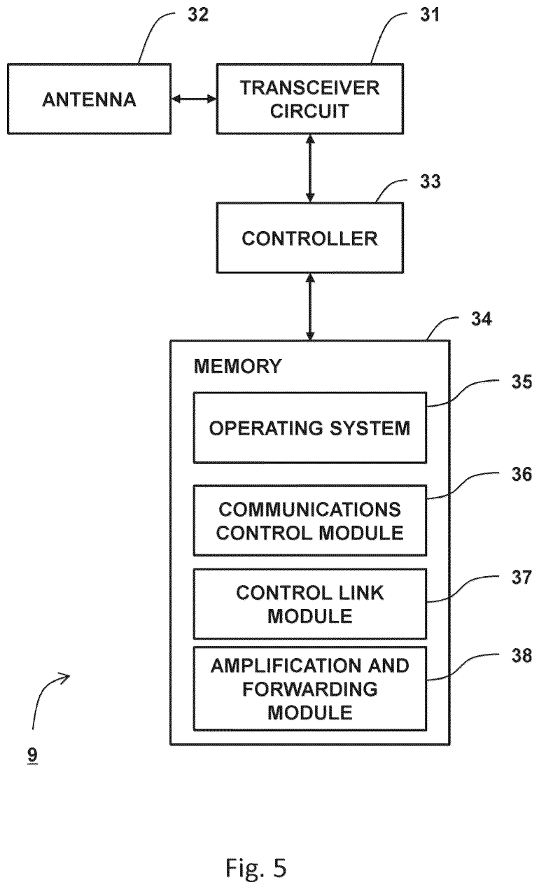

FIG. 5 is a block diagram illustrating the main components of the NCR 9 shown in FIG. 1. As shown, the NCR 9 includes a transceiver circuit 31 which is operable to transmit signals to and to receive signals from one or more UEs 3 and the base station 5 via one or more antenna 32. A controller 33 controls the operation of the NCR 9 in accordance with software stored in a memory 34. The software may be pre-installed in the memory 34 and/or may be downloaded via the telecommunication network or from a removable data storage device (RMD), for example. The software includes, among other things, an operating system 35, a communications control module 36, a control link module 37 and an amplification and forwarding module 38.

The communications control module 36 is responsible for overall handling (generating/sending/receiving) of signalling between the base station 5 and the UE 3.

The control link module 37 is responsible for controlling communication via the control link with the base station 5. It will be appreciated that the control link module 37 may be configured to control the communication over the control link according to any of the examples described below. The control link module 37 may be the NCR-MT 201 illustrated in FIG. 2.

The amplification and forwarding module 38 is responsible for controlling communication with the base station 5 via the backhaul, and for controlling communication with the UE 3 via the access link. It will be appreciated that the amplification and forwarding module 38 may be configured to control the communication over the backhaul and the access link according to any of the examples described below. The amplification and forwarding module 38 may be the NCR-Fwd 202 illustrated in FIG. 2.

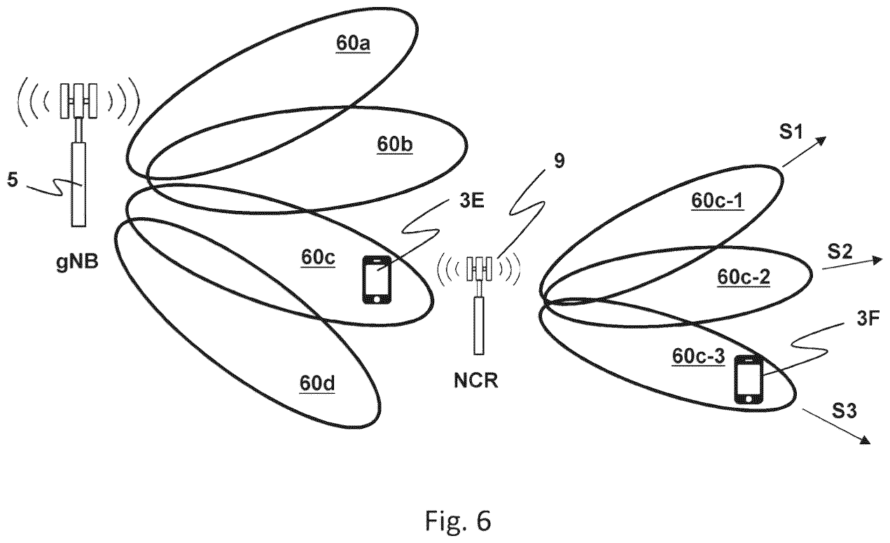

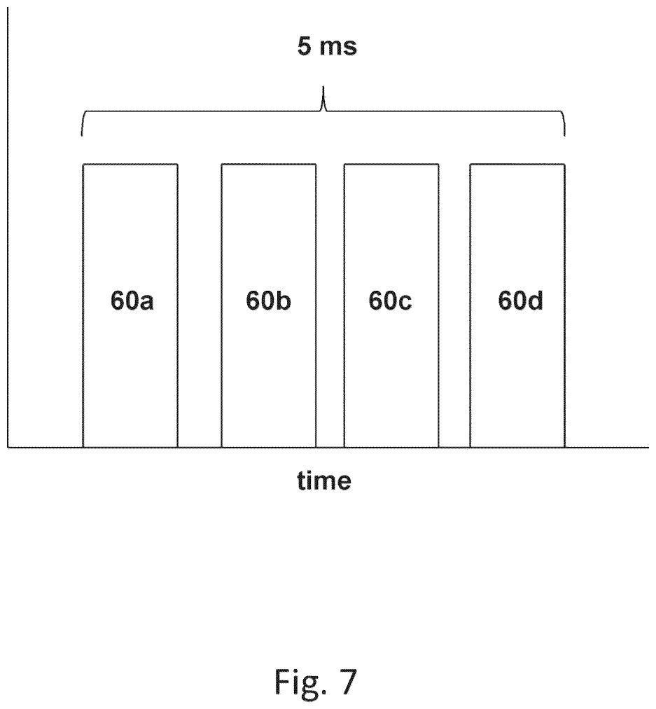

A received broadcast signal may be relayed over the access link multiple times by the NCR 9 within a pre-configured time window, but in different beam directions, thereby achieving a ‘beam sweeping’ effect (described in more detail below with reference to FIGS. 6 and 7).

The NCR 9 may be transparent to the UEs 3 in the system 1. The NCR 9 may be configured to maintain the gNB-repeater link (e.g. the backhaul link and/or the control link) and the repeater-UE link (the access link) simultaneously.

Advantageously, as described in more detail below, the NCR 9 of the present disclosure may be configured to broadcast a subset of the broadcast beams (e.g. for SSB, paging, and/or system information) broadcast by the base station 5. Similarly, the NCR 9 may receive a subset of Physical Random Access Channel (PRACH) occasions that would normally be selected by the UEs within the coverage of NCR 9, and may transmit/receive a subset of the UL/DL time/frequency/beam resources that would normally be used when the gNB performs scheduling for UEs within the coverage of the NCR 9. Beneficially, therefore, more efficient communication is achieved via the NCR 9. This can be achieved by controlling the on/off timing and receiving frequency range of the NCR 9 to match the timing of the subsets of time/frequency/beam resources.

The below-described examples will be described mainly with reference to the transmission of syncronisation signal blocks (SSB) in beamformed signals (beams). The SSB may comprise a primary synchronisation signal (PSS), a secondary synchronisation signal (SSS) and physical broadcast channel (PBCH). However, the present disclosure is not limited to transmission of SSB. In particular, the present examples may alternatively (or additionally) be used for transmission of any other suitable information (e.g. broadcast signals) such as the transmission of signals for paging, system information (SI), or System Information Block 1 (SIB1).

### Communication Procedures—First Example

FIG. 6 shows a first example of communication between a gNB 5 and a UE 3F via an NCR 9.

As shown in FIG. 6, the base station 5 transmits a plurality of beamformed signals 60a-60d (or beamformed signalling such as SSET or SIB1). For SSB transmissions, transmissions at different beam directions have different SSB indices. In the example shown in FIG. 6, each beam 60a-60d transmitted by the gNB 5 is transmitted at a different beam direction using different time resources to achieve a beam sweeping effect (described in more detail later with reference to FIG. 7). Whilst each beam 60a-60d is transmitted in a generally different direction, it will be appreciated that there may be some spatial overlap between the beams, as illustrated in FIG. 6 in which, for example, beam 60b partially overlaps beams 60a and 60c). For SIB1/SI/paging transmission, there may be one or multiple beam sweeping cycles within a SIB1/SI/paging transmission window/transmission occasion.

The SSB beams may be transmitted in the time domain as a group of SSB transmissions, which may be referred to as an ‘SSB burst set’. Each SSB in the SSB burst set may be referred to as an ‘SSB block’. FIG. 7 shows an example of a 5 ms SSB burst set in which SSB beams 60a to 60d are transmitted by the gNB 5 sequentially, resulting in a ‘beam sweeping’ effect. However, the SSB need not necessarily be transmitted as shown in the example of FIG. 7, and the burst set need not necessarily be of 5 ms duration. Various other transmission configurations in the time domain may be used depending on the configuration of the gNB 5 and the available communication resources. Moreover, whilst in the example shown in FIGS. 6 and 7 the gNB 5 transmits four SSB, the number of SSB need not necessarily be four. The number of SSB could alternatively be less than or equal to 3, or greater than or equal to 5 (for example, up to 64 SSB blocks within an SSB burst set).

Referring back to FIG. 6, a first UE 3E is located within the coverage area of SSB 60c transmitted by the gNB. A second UE 3F is located within the coverage area of SSB 60c-3 transmitted (forwarded) by the NCR 9, and can communicate with the gNB 5 via the NCR 9, by communicating with the NCR 9 over the access link (and by virtue of communication between the NCR 9 and the gNB 5 via the backhaul link).

The first UE 3E receives the signal corresponding to SSB 60c, and may also receive signals corresponding to the other SSB (e.g. the neighbouring SSB 60b and 60d). The UE 3E and the gNB 5 may perform an initial access procedure after the UE 3E has received one of the beamformed signals transmitted by the gNB 5, and the UE 3E may be configured to transmit a corresponding measurement report to the gNB 5. The UE 3E may perform measurements of, for example, syncronisation signal RSRP (SS-RSRP) or physical broadcast channel demodulation reference signal (PBCH DMRS). The UE 3E may be configured to determine an SSB index corresponding to a beam by decoding the PBCH DMRS. The UE 3E may determine a particular beam (and/or corresponding time or frequency resource) to be used for communication with the gNB 5 based on corresponding signal measurements performed by the UE 3E. Alternatively, the UE 3E may report the measurements to the gNB 5, and the gNB 5 may determine the beam (and/or corresponding time or frequency resource) to be used for communication with the UE 3E.

In this example, the second UE 3F does not receive a SSB signal directly from the gNB 5 because the UE 3F is located outside of the unextended range of the gNB 5, but receives a signal corresponding to SSB beam 60c-3 transmitted by the NCR 9.

The NCR 9 receives one or more of the beams 60a-60d transmitted by the gNB 5. In this example the NCR 9 receives at least beam 60c, and the NCR-MT 201 determines that beam 60c is the best candidate beam for communication (for example, because it has the highest received signal strength/quality). The NCR-MT 201 determines the receive time windows corresponding to beam 60c (e.g. the receive time windows for SI, SIB1, and/or paging). The receive time windows correspond to the transmit time windows for the determined beam 60c.

The NCR-MT 201 determines how and when to forward the determined beam 60c via the access link to the UE 3. In other words, the NCR-MT 201 determines the spatial, frequency and time resources to use to transmit one or more forwarded beams. The determination of how and when to forward the determined beam 60c may be based on information received from the gNB 5 via the control link. In this example the NCR-MT 201 determines, based on side control information received from the gNB 5, to transmit beams 60c-1 to 60c-3, which correspond to beam 60c transmitted in a beam sweeping effect (in other words, in this example, beams 60c-1 to 60c-3 are transmitted sequentially). However, the NCR 9 need not necessarily forward beam 60c as illustrated in FIG. 6, and any suitable spatial, time and frequency configuration for beams could be used.

Advantageously, the example described with reference to FIG. 6 does not require additional transmissions with additional resources from the gNB 5 to the NCR 9 that are beamformed towards the NCR 9 for subsequent forwarding by the NCR 9. Therefore, the overall number of transmissions/used resources from the gNB 5 is reduced, but a beam sweeping effect is nevertheless achieved in the extended area of coverage provided by the NCR 9. In other words, whilst the complexity of the NCR 9 is increased somewhat, additional transmissions (using additional resources) directed towards the NCR 9 from the gNB 5, for forwarding by the NCR 9 as separate beams in separate directions, are not used, beneficially reducing the number of transmissions needed from the gNB 5. However, since the NCR 9 transmits multiple beams based on one of the beams received from the gNB 5, and based on the side control information received from the gNB 5, a beam sweeping effect is still achieved. For SIB1/SI/paging, extra repetitions transmitted by the base station 5 for relay by the NCR 9 are similarly avoided. Moreover, for UE 3E that is arranged generally between the gNB 5 and the NCR 9, whilst the UE 3E receives beam 60c transmitted by the gNB, the UE 3E does not receive additional beams that would otherwise be beamformed towards the NCR 9 for forwarding, beneficially reducing the risk of interference at the UE 3E (and potentially reducing the number of received signals to be processed by the UE 3E).

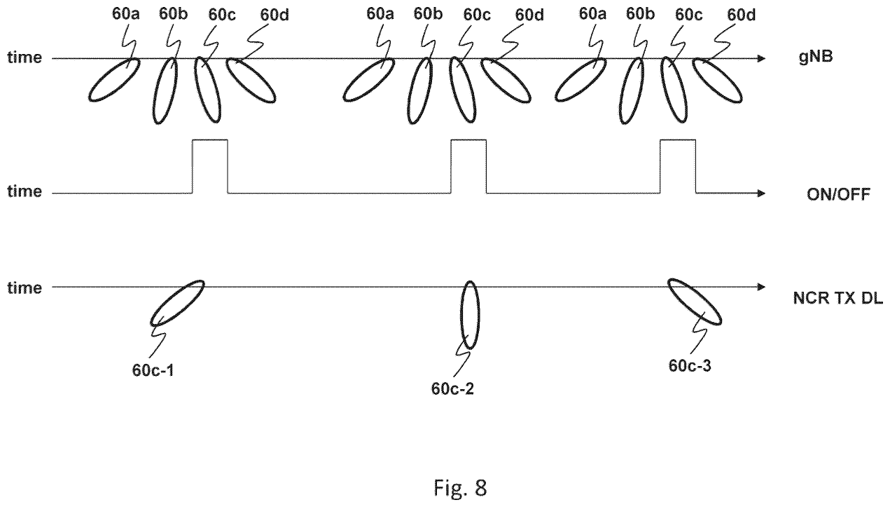

FIG. 8 shows a first option for providing the forwarding by the NCR 9. As shown in FIG. 8, the gNB 5 transmits the beams 60a to 60d. As described above, in this option the NCR 9 receives at least beam 60c, and the NCR-MT 201 determines that beam 60c is the best beam for communication. The NCR 9 may also receive side control information for controlling the NCR-Fwd. The NCR 9 determines how and when to forward beam 60c (e.g. spatial, time and/or frequency resources) on the access link between the NCR 9 and the UE 3 based on the side control information received from the gNB 5. For SI/SIB1/paging, the NCR-MT 201 determines the receive time windows of SI/SIB1/paging on beam 60c, which are equal to the transmit time windows of SI/SIB1/paging.

In this option, the NCR 9 transmits (forwards) one corresponding beamformed signal during each forwarding period (forwarding time). As shown in FIG. 8, when the NCR 9 receives a transmission over beam 60c, the NCR 9 forwards the received the signal over a corresponding beam 60c-1 in a first direction S1. When the NCR 9 receives the second transmission/repetitions over beam 60c a, the NCR 9 forwards it over a corresponding beam 60c-2 in a second direction S2. When the NCR 9 receives the third transmission/repetitions over beam 60c, the NCR 9 forwards it over a corresponding beam 60c-3 in a third direction (the first to third directions are illustrated in FIG. 6) S3. Therefore, the NCR 9 achieves a beam sweeping effect for the forwarded beam 60c, based on the side control information received from the gNB 5.

Beam directions S1/S2/S3 could be implicitly configured by the gNB as side control information, or alternatively the NCR 9 may forward the received transmissions/repetitions in all beam directions in sequence.

Whilst in the option shown in FIG. 8 the forwarded beams 60c-1 to 60c-3 are illustrated as being transmitted at substantially the same time at which the beam 60c from the gNB 5 is received, this need not necessarily be the case. Alternatively, the forwarded beams transmitted by the NCR 9 may be offset in the time domain from one or more beams received from the gNB 5. In other words, there may be an offset between the receive timing on the backhaul link and the transmit timing on the access link.

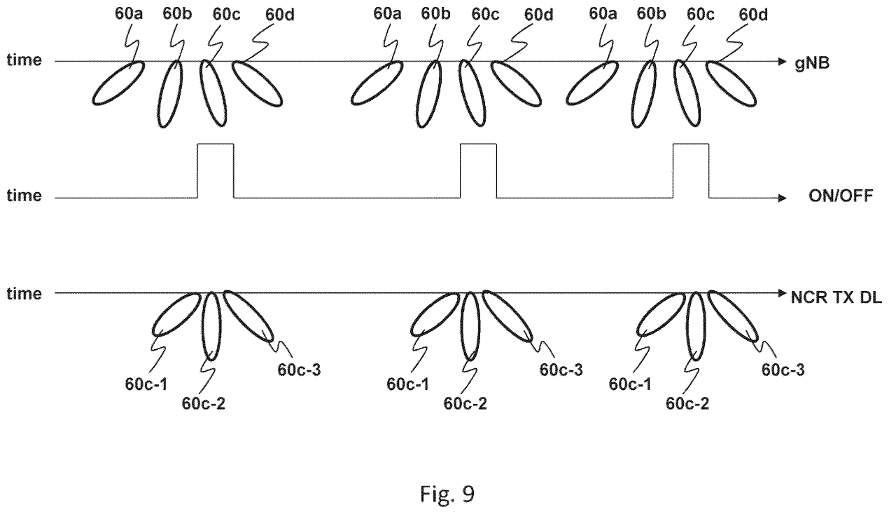

FIG. 9 shows a modification of the method illustrated in FIG. 8, in which the three transmissions over beams 60c-1 to 60c-3 are transmitted by the NCR 9 at each time the beam 60c is received from the gNB 5. For SIB1/SI/paging, the transmissions over beams 60c-1 to 60c-3 are transmitted within the SIB1/SI/paging receive/transmit window (occasion). Whilst the NCR 9 in the option illustrated in FIG. 9 may be more complex, since the NCR 9 is configured to forward the signal multiple times within the transmission interval, the configuration shown in FIG. 9 (and the configuration shown in FIG. 8) advantageously results in more transmissions of common signals in the extended coverage provided through NCR 9. Therefore, the overall performance of the system is improved.

In the options illustrated in FIGS. 8 and 9, the side control information received from the gNB 5 may comprise ON/OFF information and beam direction information for controlling the direction of beams 60c-1 to 60c-3 to achieve the beam sweeping effect. The side control information may also comprise information indicating when to receive one or more beams transmitted from the gNB 5, and timing information for controlling when to forward transmissions received in a beam to the UE 3 via the access link (it will be appreciated that the timing information for receiving and timing information for forwarding may be correlated and may be the same information). The side control information may also comprise information indicating a time period and/or direction in which to receive signals from the UE 3F.

### Communication Procedures—Second Example

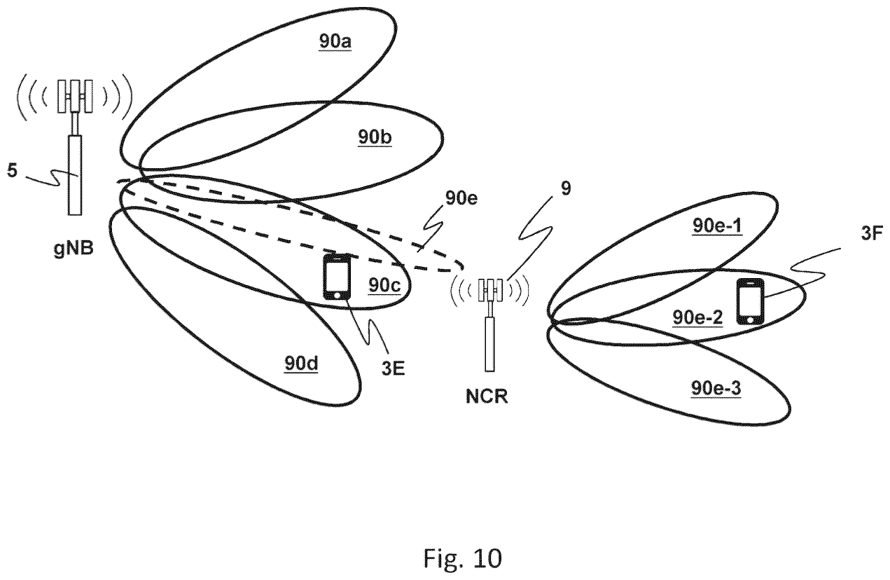

FIG. 10 shows a second example of communication between the gNB 5 and the UE 3F via the NCR 9. Advantageously, in this example, whilst an additional beam 90e is used for forwarding by the NCR 9 (in addition to beams 90a to 90d used for direct access within the unextended range of the cell), the number of additional beams used for transmission by the gNB 5 is nevertheless beneficially reduced.

In this example, the gNB 5 initially transmits using beams 90a to 90d. These beams can be used for direct access by UEs within the unextended range of the gNB 5, such as UE 3E which is located within beam 90C. The NCR 9 receives transmissions in at least one of the beams 90a-90d. In this example, the NCR 9 receives transmissions in at least beam 90c, and determines that beam 90c is the best beam for communication. The NCR 9 may receive SI/SIB including UL/DL configuration, and perform initial access to the gNB. As will be described in more detail below, the NCR 9 performs a beam management procedure using the control link between the NCR 9 and the gNB 5.

The gNB 5 then transmits using an additional beam 90e. For example the additional beam may be an additional SSB beam. For SI/SIB/paging, the additional beam corresponds to additional SI/SIB/paging repetitions. In this example, transmissions in the additional beam are transmitted to the NCR 9 using the same beam direction as for the control link. The beam 90e may be a wider beam for SSB, SIB1, SI or paging transmission, or may be a narrower beam for PDSCH transmission. For SIB1/SI/paging, the extra SIB1/SI/paging repetitions may be transmitted using a different time/frequency resource, but within the same SIB1/SI/paging transmission occasions/windows.

The side control information including the time and frequency configuration for the additional beam 90e is transmitted to the NCR-MT 201 by the gNB 5. The gNB 5 also transmits, to the NCR 9, information indicating when to receive the signal (beam) on the backhaul for relay.

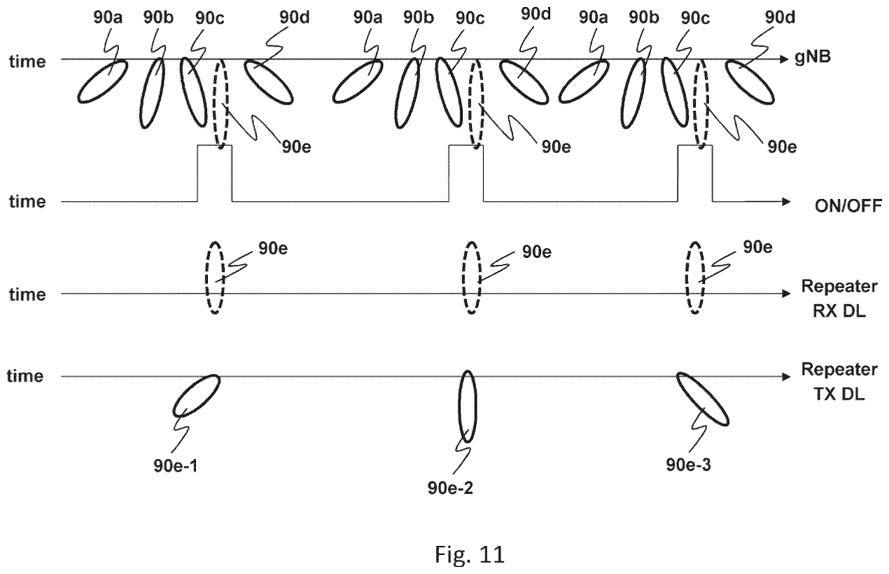

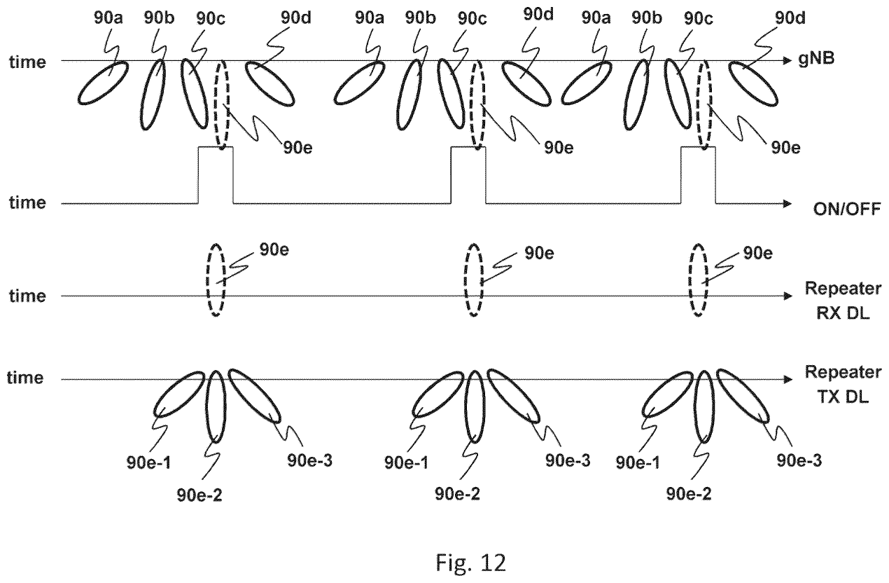

The NCR-MT 201 determines, based on the received side control information, how and when (e.g. spatial, time and frequency resources) to forward the beamformed transmissions on the access link. Two options for forwarding the transmissions in the beam on the access link are shown in FIGS. 11 and 12, described in more detail below.

FIG. 11 shows a first option for forwarding of transmissions by the NCR 9. In this option, similar to the example described above with reference to FIG. 8, in each transmission window the NCR 9 transmits one beamformed transmission. However, in contrast to the example of FIG. 8, in this example the forwarded transmissions correspond to transmissions in the additional beam 90e, rather than in the initially measured beam 90c.

As shown in FIG. 11, when the NCR 9 receives transmissions in beam 90e and side control information S1, the NCR 9 transmits using a corresponding beam 90e-1 in a first direction. When the NCR 9 receives transmissions in beam 90e and side control information S2, the NCR 9 transmits using a corresponding beam 90e-2 in a second direction. When the NCR 9 receives transmissions in beam 90e and side control information S3, the NCR 9 transmits using a corresponding beam 90e-3 in a third direction (the first to third directions are illustrated in FIG. 10). Therefore, the NCR 9 achieves a beam sweeping effect for the forwarded transmissions of beam 90e, based on the side control information received from the gNB 5. Advantageously, whilst transmission using three beams by the NCR 9 would normally require three corresponding beams for transmissions from the gNB 5 to the NCR 9 for forwarding, in this example the beam sweeping effect is nevertheless achieved with only one additional beam 90e transmitted from the gNB 5 to the NCR 9.

Whilst in the option shown in FIG. 11 the forwarded transmissions in beams 90e-1 to 90e-3 are illustrated as being transmitted at substantially the same time at which the transmissions in beam 90e from the gNB 5 is received, this need not necessarily be the case. Alternatively, the forwarded beams transmitted by the NCR 9 may be offset in the time domain from the transmissions in one or more beams received from the gNB 5. In other words, there may be an offset between the receive timing on the backhaul link and the transmit timing on the access link.

FIG. 12 shows a modification of the method illustrated in FIG. 11, in which transmissions in three beams 90e-1 to 90e-3 are transmitted by the NCR 9 each time a transmission in the beam 90e is received from the gNB 5. For SIB1/SI/paging, the transmissions in beams 90e-1 to 90e-3 are transmitted within the SIB1/SI/paging receive/transmit window (occasion). Whilst the NCR 9 in the option illustrated in FIG. 12 may be more complex, since the NCR 9 is configured to forward the signal multiple times within the transmission interval, the configuration shown in FIG. 12 (and the configuration shown in FIG. 11) advantageously avoids the need for additional beams having corresponding additional indices to be transmitted by the gNB 5 to the NCR 9 for forwarding. Therefore, the overall efficiency of the system is improved.

Whilst in the option shown in FIG. 11 the side control information is illustrated as being received each a transmission in time beam 90e is received at the NCR 9, this need not necessarily be the case. For example, only side control information S1 might be transmitted (either in the time period for receiving side control information S1 shown in FIG. 11, or alternatively in each time period for receiving side control information as illustrated in FIG. 12), in which case side control information S1 includes information indicating the configuration to be used for beams 90c-2 and 90c-3 in addition to configuration information for beam 90c-1.

In the options illustrated in FIGS. 11 and 12, the side control information received from the gNB 5 may comprise ON/OFF information and beam direction information for controlling the direction of beams 90e-1 to 90e-3 to achieve the beam sweeping effect. The side control information may also comprise information indicating when to receive the transmissions in one or more beams transmitted from the gNB 5, and timing information for controlling when to forward a transmission received in a beam to the UE 3 via the access link. The side control information may also comprise information indicating a time period and/or direction in which to receive signals from the UE 3F.

In a third option, rather than sending an additional transmission to the NCR 9 via the backhaul, the gNB 5 may alternatively transmit all of the information required for transmitting using the beams 90e-1 to 90e-3 via the control link. In this case, the control information sent via the control link includes all of the information (e.g. beam direction, time and frequency resources) required for controlling the NCR-Fwd 202 and the transmission using the beams 90e-1 to 90e-3 by the NCR 9.

### Beam Management Procedure

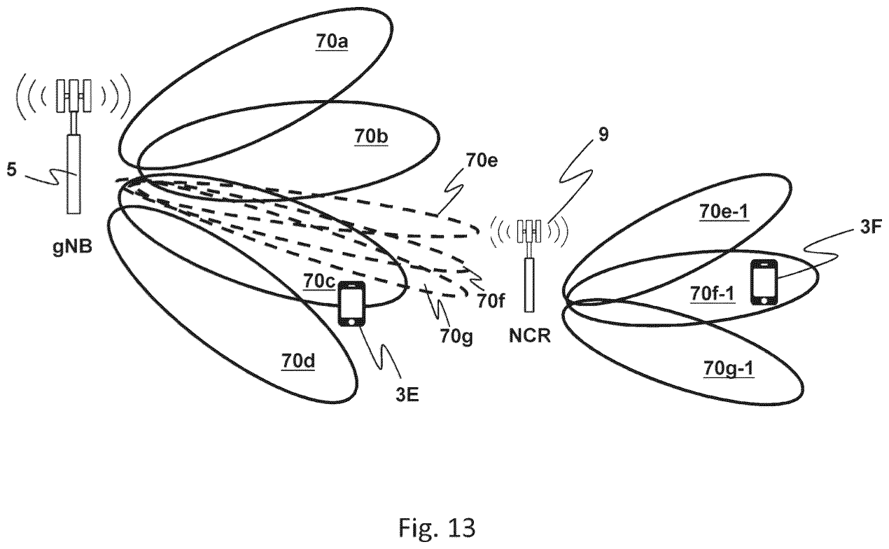

FIG. 13 shows a system in which an improved beam management procedure of the present disclosure can be implemented.

Whilst the beam management procedure will be described primarily with reference to FIG. 13 in which three additional beams 70e to 70g, for forwarding of transmissions by the NCR 9, are used the gNB 5, the beam management procedure could also be used to manage (e.g. tune) the additional beam 90e used for transmission to the NCR 9 from the gNB 5 in the example illustrated in FIG. 10. More generally, the beam management procedure can be used to manage a beam used for transmission from the gNB 5 towards the NCR 9, for reception at the NCR 9.

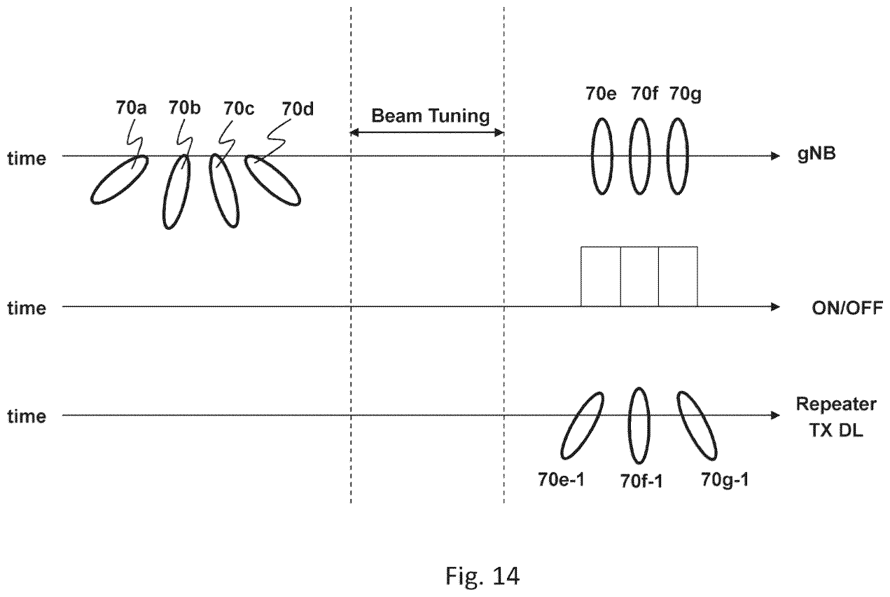

As shown in FIG. 14, the gNB 5 initially transmits using beams 70a to 70d, which can be used for direct access by UEs within the unextended range of the gNB 5. The NCR 9 receives at least one of the beams broadcast by the gNB 5, and the NCR-MT 201 performs initial access to the gNB 5.

Based on a channel state information reference signal (CSI-RS), the NCR 9 performs a beam management procedure to tune the beamforming for the control link between the NCR 9 and the gNB 5. The NCR 9 may also perform power control management for the control link. The beam tuning that is determined for the control link is then applied to the backhaul link between the gNB 5 and the NCR 9. In other words, the gNB 5 transmits using the additional beams 70e to 70g via the backhaul link using the beam tuning determined for the control link. Advantageously, therefore, narrower beams on the backhaul link are achieved, resulting in more efficient transmission, improved signal quality, and reducing the risk of interference.

As shown in FIG. 14, the gNB 5 also transmits the side control information S1 to S3 for configuring the transmission of the forwarded transmissions in beams 70e-1 to 70g-1 by the NCR 9. The NCR-MT 201 may continue to monitor beams 70a to 70d for control link management. The NCR-Fwd 202 receives transmissions in the additional beams 70e to 70g from the gNB 5 and transmits the corresponding forwarded transmissions in beams 70e-1 to 70g-1 via the access link.

The improved beam tuning for the backhaul link that advantageously makes use of the beam tuning procedure for the control link can used for any suitable beamformed transmission between the gNB 5 and the NCR 9. For example, the improved procedure can be used for the transmission of SIB1, SI, paging and/or dedicated channels, provided that the transmission is for NCR-Fwd 202 forwarding (in other words, provided that the beam is spatially directed towards the NCR 9 for forwarding). For example, the improved beam management procedure illustrated in FIG. 14 can be applied to the example illustrated in FIGS. 10 to 12 (for the additional transmission 90e that is for forwarding by the NCR 9).

### PRACH Resources

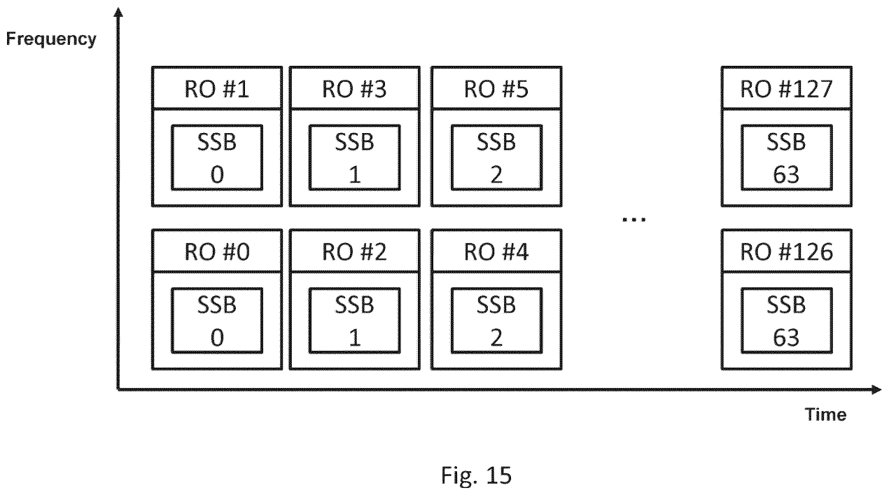

FIG. 15 shows an example of mapping between SSB indices and corresponding PRACH resources. Based on a mapping between PRACH resources and SSB index, the gNB 5 or NCR-MT 201 may determine a beam direction to monitor uplink PRACH at a particular time/frequency resource on the access link. The beam direction is equal to the beam direction of the corresponding SSB index.

A parameter ‘ssb-perRACH-Occasion AndCB-PreamblesPerSSB’ is set out below:

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) OPTIONAL, -- Need S |

ssb-perRACH-OccasionAndCB-PreamblesPerSSB CHOICE {

| | |
|---|---|
| oneEighth | ENUMERATED {n4,n8,n12,n16,n20,n24,n28,n32,n36,n40,n44,n48,n52,n56,n60,n64}, |
| oneFourth | ENUMERATED {n4,n8,n12,n16,n20,n24,n28,n32,n36,n40,n44,n48,n52,n56,n60,n64}, |
| oneHalf | ENUMERATED {n4,n8,n12,n16,n20,n24,n28,n32,n36,n40,n44,n48,n52,n56,n60,n64}, |
| one | ENUMERATED {n4,n8,n12,n16,n20,n24,n28,n32,n36,n40,n44,n48,n52,n56,n60,n64}, |
| two | ENUMERATED {n4,n8,n12,n16,n20,n24,n28,n32}, |
| four | INTEGER (1..16), |
| eight | INTEGER (1..8), |
| sixteen | INTEGER (1..4) |

}

‘ssb-perRACH-Occasion AndCB-PreamblesPerSSB’ provides information regarding the number of SSBs per RACH occasion. A value of ‘oneEighth’ indicates that one SSB is associated with 8 RACH occasions, a value of ‘oneFourth’ corresponds to one SSB associated with 4 RACH occasions, and so on. The ‘ENUMERATED’ part indicates the number of Contention Based preambles per SSB. A value of ‘n4’ corresponds to 4 Contention Based preambles per SSB, a value of ‘n8’ corresponds to 8 Contention Based (CB) preambles per SSB, and so on. The total number of CB preambles in a RACH occasion is given by ‘CB-preambles-per-SSB’*max(1, SSB-per-rach-occasion). Further details are provided in NPL 2.

FIG. 15 shows an example of PRACH receiving via the NCR 9. In this example, and ‘msg1-FDM=two’, ‘ssb-perRACH-OccasionAndCB-PreamblesPerSSB=oneHalf’. In this case, the NCR-Fwd 202 receive beam for the access link corresponds to the DL SSBO beam at RO #0 and RO #1.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 3 and NPL 4 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Each cell may have an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE 3, the access network node (base station 5) and the NCR 9 are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE 3, NCR 9 or base station 5 as a signal over a computer network, or on a recording medium. Further, the functionality performed by part or all of this software may be performed using one or more dedicated hardware circuits. However, the use of software modules is preferred as it facilitates the updating of the UE 3, NCR 9 or base station 5 in order to update their functionalities.

The above example embodiments are also applicable to ‘non-mobile’ or generally stationary user equipment 3. The above-described mobile device (UE) 3 may comprise an MTC/IoT device, a power saving UE, and/or the like.

The User Equipment 3 (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: NPL 5, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A method for a network controlled repeater, NCR the method comprising:
receiving a first beamformed transmission from an access network node; and
transmitting, based on the first beamformed transmission, a plurality of second beamformed transmissions;
wherein each of the second beamformed transmissions is transmitted in a different direction.

### (Supplementary Note 2)

The method according to Supplementary Note 1, further comprising:
performing a signal measurement of the first beamformed transmissions; and
determining, based on the signal measurement, to transmit the plurality of second beamformed transmissions based on the first beamformed transmission.

### (Supplementary Note 3)

The method according to Supplementary Note 1 or 2, further comprising determining a receive time window corresponding to the first beamformed transmission.

### (Supplementary Note 4)

The method according to any preceding Supplementary Note, further comprising receiving NCR control information for controlling at least one of transmission or reception of beamformed signals at the NCR.

### (Supplementary Note 5)

The method according to any one of Supplementary Notes 1 to 3, wherein the NCR control information indicates at least one of a spatial, time or frequency resource to use to transmit the plurality of second beamformed transmissions.

### (Supplementary Note 6)

The method according to Supplementary Note 4 or 5, wherein the NCR control information indicates at least one of a spatial, time or frequency resource to use to receive a beamformed signal.

### (Supplementary Note 7)

The method according to Supplementary Note 6, wherein the NCR control information indicates at least one of a spatial, time or frequency resource to use to receive a signal from a UE over an access link.

### (Supplementary Note 8)

The method according to Supplementary Note 6, wherein the NCR control information indicates at least one of a spatial, time or frequency resource to use to receive a signal from the access network node over a backhaul link.

### (Supplementary Note 9)

The method according to any preceding Supplementary Note, wherein the each of the plurality of second beamformed transmissions are transmitted in different transmission periods.

### (Supplementary Note 10)

The method according to any preceding Supplementary Note, wherein the plurality of second beamformed transmissions correspond to the transmission of at least one of syncronisation signal block, SSB, System Information, SI, or a paging transmission.

### (Supplementary Note 11)

The method according to any preceding Supplementary Note, wherein the first beamformed transmission is for direct access by a user equipment, UE, within an unextended transmission range of the access network node.

### (Supplementary Note 12)

The method according to any preceding Supplementary Note, wherein a beam direction corresponding to the first beamformed transmission is the same as a beam direction used for a control link between the NCR and the access network node.

### (Supplementary Note 13)

The method according to any preceding Supplementary Note, wherein transmitting the plurality of second beamformed transmissions comprises transmitting a plurality of second beamformed transmissions each time the first beamformed transmission is received at the NCR.

### (Supplementary Note 14)

The method according to any one of Supplementary Notes 1 to 12, wherein transmitting the plurality of second beamformed transmissions comprises transmitting a single one of the second beamformed transmissions each time the first beamformed transmission is received at the NCR.

### (Supplementary Note 15)

A method for a network controlled repeater, NCR, the method comprising:
receiving a first beamformed transmission from an access network node;
performing a beam tuning procedure to tune a beam that corresponds to a control link between the NCR and the access network node, to obtain a tuned beam configuration; and
using the tuned beam configuration for a beam that corresponds to a backhaul link between the NCR and the access network node.

### (Supplementary Note 16)

The method according to Supplementary Note 15, further comprising using the tuned beam configuration for a beam that corresponds to transmission of at least one of system information, SI, paging, or a dedicated channel for reception at the NCR.

### (Supplementary Note 17)

A method for an access network node, the method comprising:
transmitting a first beamformed transmission for reception by a network controlled receiver, NCR;
performing a beam tuning procedure to tune a beam that corresponds to a control link between the NCR and the access network node, to obtain a tuned beam configuration; and
using the tuned beam configuration for a beam that corresponds to a backhaul link between the NCR and the access network node.

### (Supplementary Note 18)

The method according to Supplementary Note 17, further comprising using the tuned beam configuration for a beam that corresponds to transmission of at least one of system information, SI, paging, or a dedicated channel for reception at the NCR.

### (Supplementary Note 19)

A network controlled repeater, NCR comprising:
means for receiving a first beamformed transmission from an access network node; and
means for transmitting, based on the first beamformed transmission, a plurality of second beamformed transmissions;
wherein each of the second beamformed transmissions is transmitted in a different direction.

### (Supplementary Note 20)

A network controlled repeater, NCR, comprising:
means for receiving a first beamformed transmission from an access network node;
means for performing a beam tuning procedure to tune a beam that corresponds to a control link between the NCR and the access network node, to obtain a tuned beam configuration; and
means for using the tuned beam configuration for a beam that corresponds to a backhaul link between the NCR and the access network node.

### (Supplementary Note 21)

An access network node comprising:
means for transmitting a first beamformed transmission for reception by a network controlled receiver, NCR;
means for performing a beam tuning procedure to tune a beam that corresponds to a control link between the NCR and the access network node, to obtain a tuned beam configuration; and
means for using the tuned beam configuration for a beam that corresponds to a backhaul link between the NCR and the access network node.

This application is based upon and claims the benefit of priority from Great Britain Patent Application No. 2211654.5, filed on Aug. 9, 2022, the disclosure of which is incorporated herein in its entirety by reference.

### REFERENCE SIGNS LIST

1 mobile (cellular or wireless) telecommunication system
3 mobile device
5 base station
6 cell(s)
7 core network
8-1 Access and Mobility Management Function (AMF)
8-2 control plane function (CPF)
8-3 user plane function (UPF)
8-4 Session Management Function (SMF)
8-5 Operations, Administration and Maintenance (OAM) function
9 network controlled repeater (NCR)
10 data network
21 transceiver circuit
22 antenna
23 controller
24 user interface
25 memory
26 operating system
27 communications control module
31 transceiver circuit
32 antenna
33 controller
34 memory
35 operating system
36 communications control module
37 control link module
38 amplification and forwarding module
41 transceiver circuit
42 antenna
43 network interface
44 controller
45 memory
46 operating system
47 communications control module
48 control link module
49 backhaul module
201 NCR-MT
202 NCR-Fwd

What is claimed is:

1-16. (canceled)

17. A method for a network controlled repeater (NCR), the method comprising:
receiving, from an access network node via a control link, configuration information for at least one beam used in one or more access links between the NCR and at least one user equipment (UE); and
forwarding data from the access network node via a backhaul link to the at least one UE via the one or more access links using the at least one beam configured with the configuration information, wherein
the configuration information indicates at least one time resource set for the forwarding and a periodicity for the at least one time resource set.

18. The method according to claim 17, further comprising:
receiving, from the access network node, control information for indicating at least one beam for use by the forwarding, wherein
the forwarding is performed using the at least one beam indicated by the control information.

19. The method according to claim 18, wherein
the control information is transmitted in a Medium Access Control (MAC) Control Element (CE).

20. The method according to claim 18, wherein
the control information indicates the at least one beam used for:
backhaul link transmission between the NCR and access network node, or access link transmission between the NCR and the at least one UE.

21. The method according to claim 17, wherein
timing for transmission and reception on the backhaul link follows timing for transmission and reception on the control link, respectively.

22. The method according to claim 17, further comprising:
receiving information indicating when to receive and forward the data from/to the access network node.

23. A method for an access network node, the method comprising:
transmitting, to a network controlled repeater (NCR), configuration information for at least one beam used in one or more access links between the NCR and at least one user equipment (UE); and
transmitting data to the NCR to cause the NCR to forward the data to the at least one UE via the one or more access links using the at least one beam configured with the configuration information, wherein
the configuration information indicates at least one time resource set for the forwarding and a periodicity for the at least one time resource set.

24. A network controlled repeater (NCR), comprising:
at least one memory storing instructions; and
at least one processor configured to process the instructions to:
receive, from an access network node, configuration information for at least one beam used in one or more access links between the NCR and at least one user equipment (UE); and
forward data from the access network node to the at least one UE via the one or more access links using the at least one beam configured with the configuration information, wherein
the configuration information indicates at least one time resource set for the forwarding and a periodicity for the at least one time resource set.

25. An access network node comprising:
at least one memory storing instructions; and
at least one processor configured to process the instructions to:
transmit, to a network controlled repeater (NCR), configuration information for at least one beam used in one or more access links between the NCR and at least one user equipment (UE); and
transmit data to the NCR to cause the NCR to forward the data to the at least one UE via the one or more access links using the at least one beam configured with the configuration information, wherein
the configuration information indicates at least one time resource set for the forwarding and a periodicity for the at least one time resource set.
